(19) United States
(12) Patent Application Publication
(10) Pub. No.: US 2006/0203438 A1
(43) Pub. Date: Sep. 14, 2006

(54) DISPLAY DEVICE WITH A DISPLAY BASE

(76) Inventors: Chun-Chao Chiu, Taipei Hsien (TW); Wei-Chieh Chen, Tao-Yuan Hsien (TW)

Correspondence Address: NORTH AMERICA INTELLECTUAL PROPERTY CORPORATION, P.O. BOX 506, MERRIFIELD, VA, 22116, US

(21) Appl. No.: 11/308,129

(22) Filed: Mar. 8, 2006

(30) Foreign Application Priority Data
Mar. 8, 2005 (TW) 094106948

(51) Int. Cl. G06F 1/16

(52) U.S. Cl. 361/681; 361/679

(57) ABSTRACT

A display device includes a display base including an engaging piece, and a display monitor including a housing including a track. A stopper is installed on the housing for being pressed down by the engaging piece of the display base and for springing back so as to fix the combination of the display base and the display monitor when the engaging piece is slid into the track and up to the housing.

### BACKGROUND OF THE INVENTION

1. Field of the Invention

The present invention relates to a display device, and more particularly, to a display device with an engaged display base.

2. Description of the Prior Art

Liquid crystal displays (LCDs) have been most widely utilized in mobile displays as a replacement for the cathode ray tube (CRT), due to features of excellent picture quality, light weight, thin size, and low power consumption.

Please refer to FIG. 1. FIG. 1 is an assembly diagram of a display device 10 in the prior art. The display device 10 includes a display monitor 12, and a display base 14 for supporting the display monitor 12. The display base 14 includes an engaging piece 16. The engaging piece 16 can be a flat piece of metal. The display monitor 12 includes a housing 18 including a first plane 20 and a second plane 22 perpendicular to the first plane 20, and two wedge-shaped structures 24 each including a hole 26. Two tracks 28 are formed between the two wedge-shaped structures 24 and the second plane 22. The engaging piece 16 of the display base 14 slides in the tracks 28 during assembling. After the engaging piece 16 slides to an end of the wedge-shaped structures 24 and ideally contacts the first plane 20 in balance, two screws 30 deposed inside two holes 26 of the wedge-shaped structures 24 are screwed through the holes 26 of the engaging piece 16, so as to combine the display monitor 12 and the display base 14.

A deflection between the display monitor 12 and the display base 14 easily happens due to the unequal torque of each screw 30. That is, the engaging piece 16 in the tracks 28 cannot contact the first plane 20 in balance so that the display monitor 12 is tilted relative to the display base 14.

Please refer to FIG. 2. FIG. 2 is a schematic diagram of the display monitor 12 tilted relative to the display base 14 in the prior art. If the engaging piece 16 in the tracks 28 cannot contact the first plane 20 in balance, the display monitor 12 will be tilted relative to the display base 14 resulting in a low-quality end product.

### SUMMARY OF THE INVENTION

It is therefore a primary objective of the claimed invention to provide a display device with a display base for solving the above-mentioned problem.

According to claimed invention, a display device includes a display base including an engaging piece, and a display monitor connecting to the display base. The display monitor includes a housing with a track thereon, and a stopper installed on the housing for being pressed down by the engaging piece and for springing back so as to fix the display base with the display monitor when the engaging piece is slid in the track up to the housing.

According to claimed invention, a display device includes a display monitor including a housing and a stopper deposed on the housing. The display device further includes a display base initially sliding on the housing to reach a predetermined position and engage with the stopper.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is an assembly diagram of a display device in the prior art.

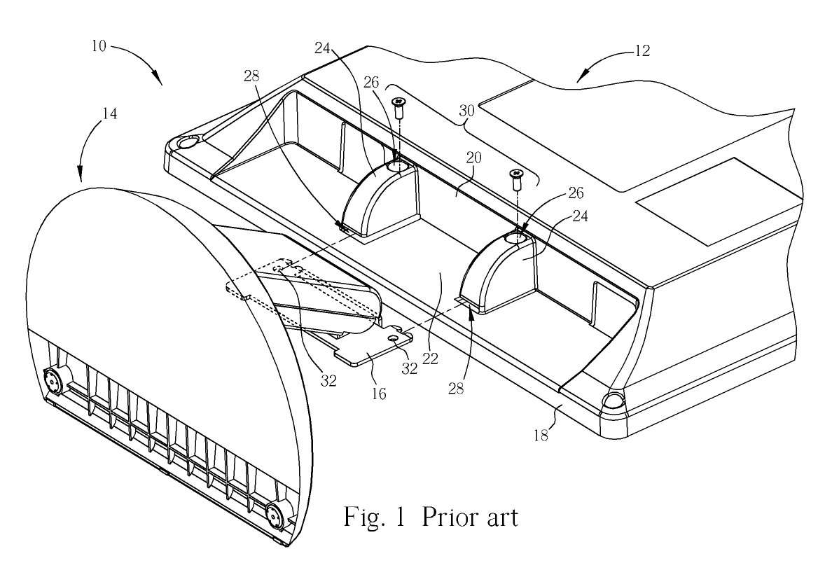

FIG. 2 is a schematic diagram of a display monitor tilted relative to a display base in the prior art.

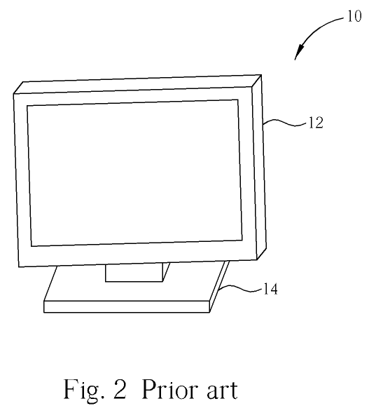

FIG. 3 is a schematic diagram of a display device according to the present invention.

FIG. 4 is an assembly diagram of the display device of a first embodiment according to the present invention.

FIG. 5 is an assembly diagram of an engaging piece reaching a predetermined position in the first embodiment according to the present invention.

FIG. 6 is an assembly diagram of the display device of a second embodiment according to the present invention.

FIG. 7 is an assembly diagram of the engaging piece reaching a predetermined position in the second embodiment according to the present invention.

### DETAILED DESCRIPTION

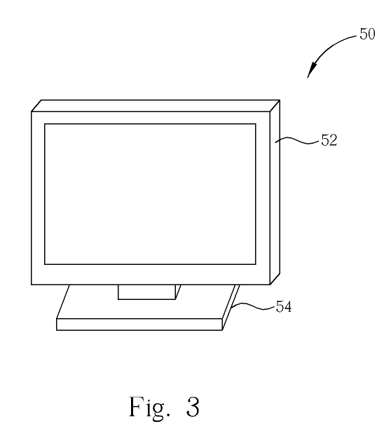

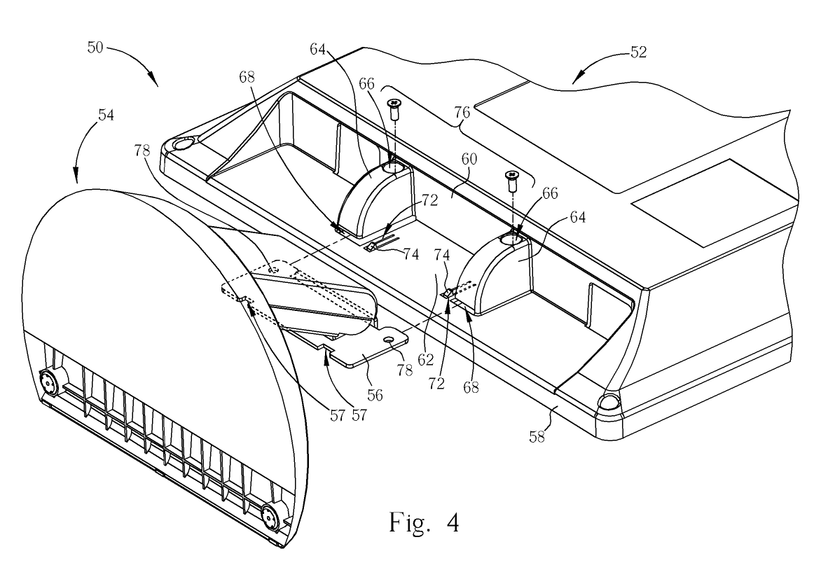

Please refer to FIG. 3. FIG. 3 is a schematic diagram of a display device 50 according to the present invention. The display device 50 includes a display monitor 52, which can be a liquid crystal display, and a display base 54 for supporting the display monitor 52. Please refer to FIG. 4. FIG. 4 is an assembly diagram of the display device 50 of a first embodiment according to the present invention. The display base 54 includes an engaging piece 56. The engaging piece 56 can be a flat piece of steel. There are two notches 57 formed on the engaging piece 56. The display monitor 52 includes a housing 58 including a first plane 60 and a second plane 62 perpendicular to the first plane 60, and two wedge-shaped structures 64 each including a hole 66. Two tracks 68 are preferably formed between the two wedge-shaped structures 64 and the second plane 62. The engaging piece 56 of the display base 54 can be slid on the tracks 68. The display monitor 52 further includes two stoppers 72. The stoppers 72 can be made of plastic or stainless steel, or another material. The stoppers 72 also can be connected to the housing 58 as a monolithic structure. The stoppers 72 are positioned on the second plane 62 of the housing 58. Each stopper 72 includes an inclined plane 74. The stopper 72 can be a hooked cantilever for being pressed down by the engaging piece 56 of the display base 54 and for springing back when the engaging piece 56 is slid into the tracks and contacts the first plane 60 of the housing 58 so as to combine the display monitor 52 with the display base 54. The display device 50 further includes a lock mechanism 73 for locking the engaging piece 56 of the display base 54 and the housing 58 of the display monitor 52. The lock mechanism 76 can be a screw or a rivet to be threaded inside the hole 78 on the engaging piece 56 through the holes 66 of the wedge-shaped structures 64 so as to combine the display monitor 52 and the display base 54.

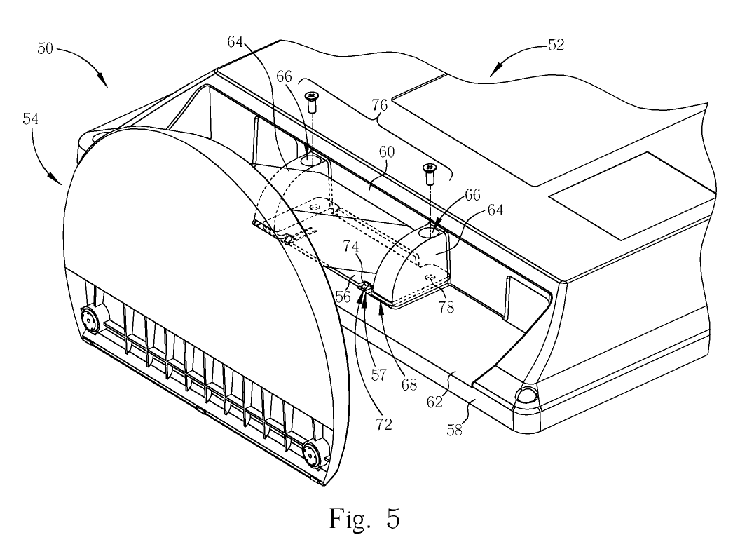

The assembly of the display monitor 52 and the display base 54 is described as follows. First the engaging piece 56 of the display base 54 is pushed into the tracks 68. The edge of the engaging piece 56 can be aligned with the wedge-shaped structures 64 so as to locate the engaging piece 56 precisely. At the beginning of pushing the engaging piece 56 into the tracks, the inclination of the inclined plane 74 can guide the engaging piece 56 into the tracks smoothly. During assembling, the stoppers 72 will be pressed down by the engaging piece 56 until the engaging piece 56 is slid to contact the first plane 60 on the bottom of the wedge-shaped structures 64, that is, until the engaging piece 56 is slid into the tracks 68 completely (as FIG. 5 shows). At this moment, the stoppers 72 are no longer pressed down by the engaging piece 56 and thus spring back. Please refer to FIG. 5. FIG. 5 is an assembly diagram of the engaging piece 56 reaches a predetermined position in the first embodiment according to the present invention. The stoppers 72 have sprung back so as to mate with the notches 57 of the engaging piece 56. The lock mechanism 76 (two screws) can be threaded inside two holes 78 on the engaging piece 56 through the holes 66 of the wedge-shaped structures 64 so as to combine the display monitor 52 and the display base 54.

The engaging piece 56 is located and constrained on the housing 58 by the stoppers 72. No deflection occurs between the display monitor 52 and the display base 54 because the engaging piece 56 in the tracks 68 contact the first plane 60 in balance when the screws are threaded into the holes 78 on the engaging piece 56.

It should be understood that even no track provided on the housing, the engaging piece still can be positioned on the housing by the stoppers, and the display monitor and the display base still can be combined by threading the lock mechanism through the engaging piece.

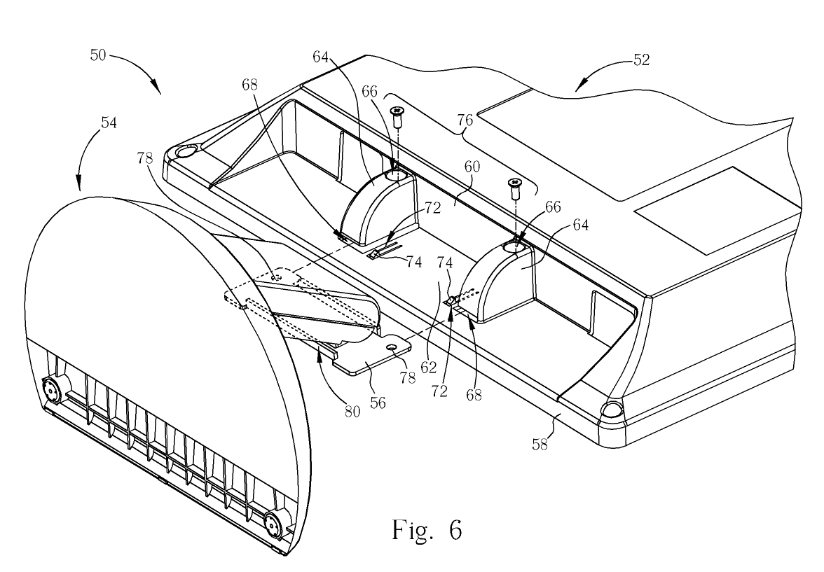

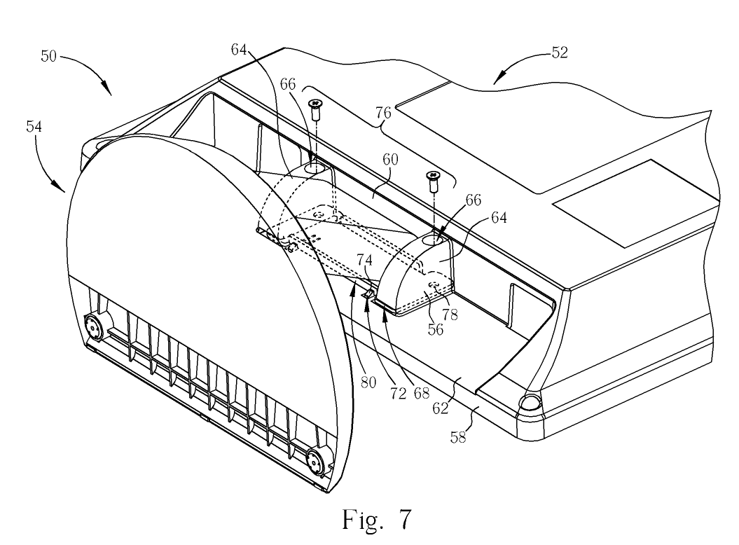

Please refer to FIG. 6. FIG. 6 is an assembly diagram of the display device 50 of a second embodiment according to the present invention. The difference between the first embodiment and the second embodiment is that the engaging piece 56 includes a shelf 80 for constraining the stoppers 72 when the stoppers 72 spring back. That is, when the engaging piece 56 is slid on the tracks 68 on the bottom of the wedge-shaped structures 64 to completely contact the first plane 60, the stoppers 72 are not pressed down by the engaging piece 56 anymore and spring back (as FIG. 7 shows). At this moment, the shelf 80 can constrain the stoppers 72. Please refer to FIG. 7. FIG. 7 is an assembly diagram of the engaging piece 56 reaching the predetermined position in the second embodiment according to the present invention. The difference between the first embodiment and the second embodiment is that the stoppers 72 are mated with the notches 57 of the first embodiment shown in FIG. 6, while the shelf 80 is utilized for constraining the stoppers 72 of the second embodiment. The notches 57 of the first embodiment and the shelf 80 of the second embodiment are utilized for constraining the movement of the engaging piece 56 at the side near the stoppers 72 so that no deflection (or tilt) occurs between the display monitor 52 and the display base 54.

In contrast to the conventional display device, the display device with a positioning mechanism (such as the stopper described above) for combining the display base with the display monitor according to the present invention can prevent deflection (or tilt) between the display monitor and the display base.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A display device comprising:
a display base including an engaging piece; and
a display monitor connecting to the display base comprising:
a housing with a track thereon; and
a stopper installed on the housing for being pressed down by the engaging piece and for springing back so as to fix the display base with the display monitor when the engaging piece is slid in the track up to the housing.

2. The display device of claim 1, wherein the engaging piece is a flat piece of steel.

3. The display device of claim 1 further comprising a lock mechanism for locking the engaging piece of the display base to the housing of the display monitor.

4. The display device of claim 3, wherein the lock mechanism is a screw.

5. The display device of claim 1, wherein the stopper is a hook.

6. The display device of claim 5, wherein the engaging piece comprises a notch corresponding to the stopper to contain the stopper when the engaging piece reaches a predetermined position.

7. The display device of claim 5, wherein the engaging piece further comprises a shelf for constraining the stopper when engaging piece reaches to a predetermined position.

8. The display device of claim 1 wherein the stopper is made of plastic.

9. The display device of claim 1 wherein the stopper is made of stainless steel.

10. A display device comprising:
a display monitor comprising:
a housing; and
a stopper deposed on the housing ; and
a display base initially sliding on the housing to reach a predetermined position and engage with the stopper.

11. The display device of claim 10, wherein the display base comprises an engaging piece engaging with the stopper.

12. The display device of claim 11, wherein the stopper is a hooked cantilever and the engaging piece includes a notch engaging with at least a part of the hooked cantilever.

13. The display device of claim 11, wherein the stopper is a notch and the engaging piece comprises a protrusion located in the notch.

14. The display device of claim 11 further comprising a track deposed on the housing, wherein when the engaging piece slides in the track and reaches to the predetermined position, the stopper engages with the engaging piece.

15. The display device of claim 11 further comprising a lock mechanism for locking the engaging piece to the housing.

16. The display device of claim 15, wherein the lock mechanism is a screw or a rivet.

17. The display device of claim 10, wherein the stopper is connected to the housing in a monolithic structure.
